(19) United States
(12) Patent Application Publication
(10) Pub. No.: US 2006/0111547 A1
(43) Pub. Date: May 25, 2006

(54) Bottom layer resist polymers for photolithography and methods of manufacturing the same

(76) Inventors: Mitsuhiro Hata, Suwon-si (KR); Sang-gyun Woo, Yongin-si (KR); Yool Kang, Seongnam-si (KR); Man-hyoung Ryoo, Hwaseong-si (KR); Hyun-woo Kim, Hwaseong-si (KR); Jung-hwan Hah, Hwaseong-si (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/283,841

(22) Filed: Nov. 22, 2005

(30) Foreign Application Priority Data
Nov. 22, 2004 (KR) 2004-95893

(51) Int. Cl. C08G 64/00

(52) U.S. Cl. 528/196

(57) ABSTRACT

In one aspect, a bottom layer resist polymer has an expanded p-electron conjugation system based on a monomer unit having a 3,3′-diindenyl structure. The bottom layer resist polymer of this aspect is composed of a repeat unit having the 3,3′-diindenyl structure represented by the following formula: 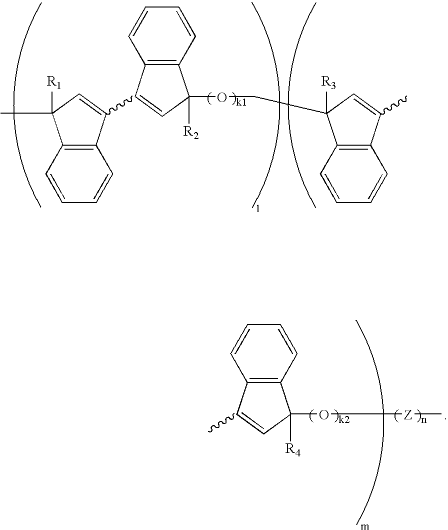
where l, m and n are respective mole fractions of monomer units of the polymer, where l+m+n=1, where l=0.1 to 0.9, m=0.1 to 0.9, and n=0 to 0.8, where each of k₁ and k₂ is independently 0 or 1, and each of R₁, R₂, R₃ and R₄ is independently a hydrogen atom or an unsaturated hydrocarbon, and where Z is a monomer unit including a bisphenol derivative.

### BACKGROUND OF THE INVENTION

1. Field of the Invention

The present invention generally relates to resist compositions utilized in photolithography processes during the manufacture of semiconductor devices, and more particularly, the present invention relates to polymers which can utilized as the bottom layer resist of a bi-layer resist (BLR) or a multi-layer resist (MLR), and to methods of manufacturing such polymers.

A claim of priority is made to Korean Patent Application No. 10-2004-0095893, filed on Nov. 22, 2004, in the Korean Intellectual Property Office, the disclosure of which is incorporated herein in its entirety by reference.

2. Description of the Related Art

Conventional photolithography processes utilize a single layer of resist material. However, in an effort to enhance resolutions in photolithography, the use of multi-layer resists (MLR) and bi-layer resists (BLR) having a high resistance to dry etching has recently been investigated. The MLR generally includes a top layer resist, a bottom layer resist, and one or more intermediate layers, while the BLR includes a top layer resist and a bottom layer resist. In BLR and MLR processes, a Si-containing resist material is used as the top layer resist. When patterning is performed using O₂ reactive ion etching (RIE), the Si contained in the top layer resist is glassificated into SiOx, thus hardening the surface of the resist layer. The hardened layer acts as an etch mask such that the pattern of the top layer resist is transferred to the bottom layer Iresist. Then, the pattern of the bottom layer resist is transferred under specific etching conditions to an underlying layer to be etched, thereby forming a desired pattern.

An interlayer insulating material having a low dielectric constant has been developed as the bottom layer resist of the MLR and BLR. For example, an amorphous carbon layer (ACL) formed by using plasma enhanced chemical vapor deposition (PECVD) of unsaturated hydrocarbon has high dry etch durability and mechanical strength because of its mutually-fused aromatic ring and local diamond-like structure. However, manufacturing ACL is expensive and requires additional equipment. In addition, ACL has low transparency at 633 nm that is necessary for layer-to-layer alignment, and low throughput.

Another candidate for the bottom layer resist is poly(arylene ether) (PAE). PAE has cost and process-related advantages over ACL since formation of the polymer structure of PAE layer can be executed using a coater apparatus. In addition, PAE has good transparency 633 nm and can be formed to a substantial thickness that is preferable for successive pattern transfer processes to an underlying layer by etching. However, the vertical profile of the PAE bottom layer resist after the pattern transfer exhibits negative bowing due to lack of mechanical strength.

In order to improve mechanical strength of PAE, crosslinking groups may be introduced to the backbone of the polymer. For example, F. L. Hedberg and F. E. Arnold, J. Polym. Sci., Polym. Chem. Ed. 14, 2607-19(1976), and A. Banihashemi and C. S. Marvel, J Polym. Sci., Polym. Chem. Ed. 15, 2653-65(1977) disclose the use of pendant phenylethynyl groups attached to the polymer backbone; and U.S. Pat. No. 6,060,170 discloses the use of various diarylhydroxymethyl and 9-(9-hydroxyfluorenyl) groups which can be attached to the polymer backbone.

### SUMMARY OF THE INVENTION

According to an aspect of the present invention, there is provided a bottom layer resist polymer having a repeat unit having a 3,3′-diindenyl structure represented by formula 1: 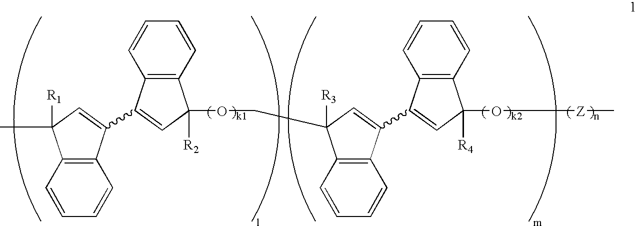
where each of l, m and n is a mole fraction of respective monomer units, l+m+n=1, l=0.1 to 0.9, m=0.1 to 0.9, n=0 to 0.8, each of k₁ and k₂ is 0 or 1, each of R₁, R₂, R₃ and R₄ is a hydrogen atom or an unsaturated hydrocarbon, and Z is a monomer unit composed of a bisphenol derivative. The monomer unit Z may optionally be selected from the group consisting of monomer units represented by formula 2:

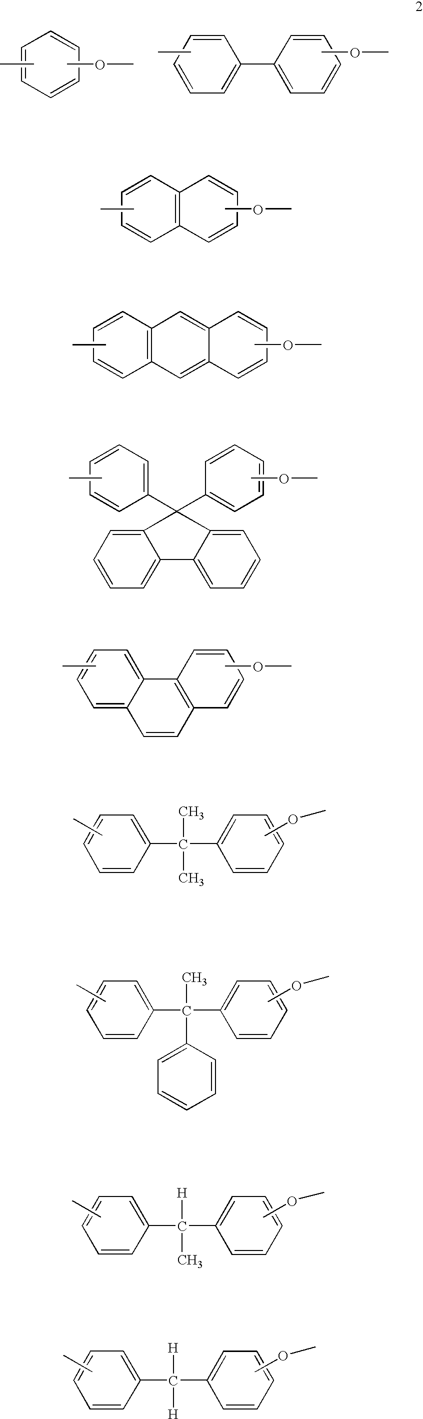

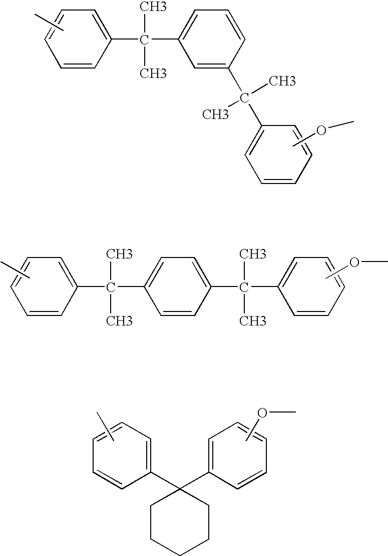

According to another aspect of the present invention, there is provided a method of manufacturing a bottom layer resist polymer. The method comprises treating a polymer comprising a repeat unit having a 3,3′-diindenyl structure represented by formula 3 with a metal reagent and an unsaturated hydrocarbon halide. 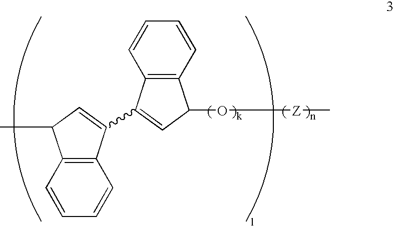
where each of l and n is a mole fraction of respective monomer units, l+n=1, l=0.1 to 1.0, n=0 to 0.9, k is 0 or 1, and Z is a monomer unit composed of a bisphenol derivative.

The metal reagent may include a compound selected from the group consisting of alkyl lithium, aryl lithium, lithium acetylide ethylene diamine complex, lithium amide, lithium aluminum hydride, lithium tetrahydroborate, lithium triethylborohydride, lithium hydride, sodium amide, sodium aluminum hydride, sodium tetrahydroborate, sodium hydride, potassium hydride, potassium tetrahydroborate, alkyl magnesium bromide, alkenyl magnesium bromide, ethynyl magnesium bromide, allyl magnesium bromide, aryl magnesium bromide, alkyl magnesium chloride, alkenyl magnesium chloride, ethynyl magnesium chloride, allyl magnesium chloride, aryl magnesium chloride, benzyl magnesium chloride, magnesium hydride, and calcium hydride.

The unsaturated hydrocarbon halide may be represented by formula 4. 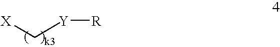
where X is Cl, Br, or I; Y is one of a double bond and a triple bond; R is one of hydrogen and a C1 to C10 alkyl group; and k₃ is an integer from 0 to 10.

According to another aspect of the present invention, there is provided a method of forming a bottom layer resist polymer. The method comprises treating a polymer composed of a repeat unit having a 3,3′-diindenyl structure represented by formula 5 with a metal reagent. 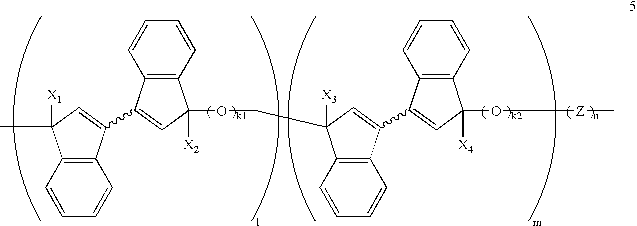
where each of l, m and n is a mole fraction of respective monomer units, l+m+n=1, l=0.1 to 0.9, m=0.1 to 0.9, n=0 to 0.8, each of k₁ and k₂ is independently 0 or 1, each of X₁, X₂, X₃ and X₄ is independently a hydrogen atom or a halogen atom, and Z is a monomer unit composed of a bisphenol derivative.

The metal reagent may be represented by formula 6. 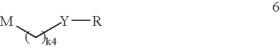
where M is lithium, magnesium chloride, magnesium bromide, copper, silver, sodium, potassium, or mercury, Y is one of a double bond and a triple bond, R is one of a hydrogen atom or a C1-C10 alkyl group, and k₄ is an integer from 0 to 10.

According to another aspect of the present invention, there is provided a method of forming the bottom layer resist polymer. The method comprises treating a polymer composed of a repeat unit having a 3,3′-diindenyl structure represented by formula 3 with a metal reagent, and then with a halogenation reagent.

The metal reagent may include a compound selected from the group consisting of alkyl lithium, aryl lithium, lithium acetylide ethylene diamine complex, lithium amide, lithium aluminum hydride, lithium tetrahydroborate, lithium triethylborohydride, lithium hydride, sodium amide, sodium aluminum hydride, sodium tetrahydroborate, sodium hydride, potassium hydride, potassium tetrahydroborate, alkyl magnesium bromide, alkenyl magnesium bromide, ethynyl magnesium bromide, allyl magnesium bromide, aryl magnesium bromide, alkyl magnesium chloride, alkenyl magnesium chloride, ethynyl magnesium chloride, allyl magnesium chloride, aryl magnesium chloride, benzyl magnesium chloride, magnesium hydride, and calcium hydride.

The halogenation reagent may be a compound selected from the group consisting of Br₂, I₂, N-bromosuccinimide, and N-chlorosuccinimide.

The method of this aspect may further include oxidation polymerization of 3,3′-di(1-hydroxy-indenyl) represented by formula 7 in the presence of sulfuric acid.

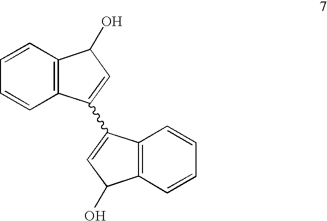

In addition, the method of this aspect may further include forming the 3,3′-di(1-hydroxy-indenyl) by treating 3,3′-di(1-halo-indenyl) represented by formula 8 with a sodium carbonate. 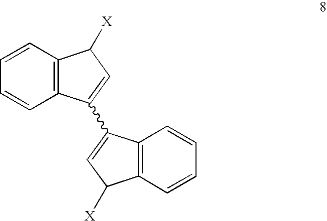
where X is Cl, Br or I.

In addition, the method of this aspect may further included condensation polymerization of 3,3′-di(1-halo-indenyl) and the bisphenol derivative in the presence of potassium carbonate.

3,3′-di(1-halo-indenyl) may be manufactured by reacting 1,1′-diindenyl with 2 equivalents of the metal reagent to form diindenyl dianion represented by formula 9, and reacting the diindenyl dianion with two equivalents of a halogenation reagent.

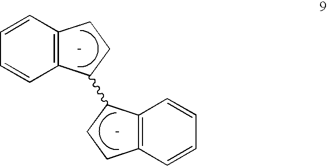

The metal reagent may be reacted with 1,1-diindenyl at a temperature of −90° C. to −30° C. and the reaction temperature may be increased until the diindenyl dianion is formed.

In addition, the halogenation reagent may be reacted with the diindenyl dianion at a temperature −90° C. to −30° C. and the reaction temperature may be increased until the 3,3′-di(1-halo-indenyl) is formed.

1,1′-diindenyl may be formed by reacting indene with one equivalent of the metal reagent, and reacting the reaction product with a half equivalent of the halogenation reagent. The metal reagent may be reacted with the indene at a temperature of −90° C. to −30° C. The halogenation reagent may be reacted with the reaction product at a temperature of −90° C. to −30° C., and the reaction temperature may be increased until the 1,1′-diindenyl is formed.

In addition, the method of this aspect may further include reacting 1,1′-diindenyl with two equivalents of the metal reagent to form diindenyl dianion represented by formula 9, and reacting the diindenyl dianion with one equivalent of the halogenation reagent.

The reaction between the diindenyl dianion with the halogenation reagent may occur at a temperature of −90° C. to −30° C. until a diindenyl dianion intermediate polymer represented by formula 10 is formed.

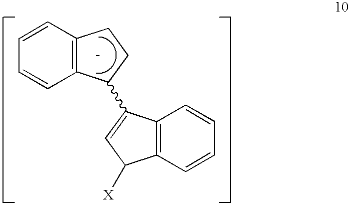

In addition, the reaction temperature may be increased until a polymer composed of a repeat unit having a 3,3′-diindnyl structure is obtained from the diindenyl dianion intermediate.

Polymers according to embodiments of the present invention may have an expanded p-electron conjugation system based on a monomer unit having a 3,3′-diindenyl structure. In methods according to embodiments of the present invention, reactions from a starting material to a diindenyl monomer, or to a 3,3′-diindenyl polymer, may be performed in a single reaction pot without an isolation process of an intermediate product, thus increasing product yield and decreasing manufacturing costs.

### DETAILED DESCRIPTION OF PREFERRED EMBODIMENTS

A polymer according to at least one embodiment of the present invention has an expanded p-electron conjugation system compared to its parent indene based on a monomer unit having a 3,3′-diindenyl structure.

A method of manufacturing the polymer according to at least one embodiment of the present invention is characterized by its extensive uses of a metal reagent for deprotonation and a successive halogenation reaction. Further, reactions from a starting material to a diindenyl monomer, or to a 3,3′-diindenyl polymer, may occur in a single reaction pot respectively without isolations of intermediates, thus increasing product yield and decreasing production costs.

Indene is a common aromatic compound with an allylic proton highly susceptible to deprotonation. With a metal reagent such as n-butyl lithium (nBuLi), Indene can be easily deprotonated to produce an indenyl anion that is very likely to be involved in various electrophilic reactions.

A method of manufacturing a polymer according to an embodiment of the present invention will now be described. First, a diindenyl monomer unit of 3,3′-di(1-X-indenyl) where X is Cl, Br, or I is synthesized using Reaction Scheme 1 and Reaction Scheme 2.

Reaction Scheme 1 is a first reaction used to form a diindenyl monomer unit of 3,3′-di(1-X-indenyl).

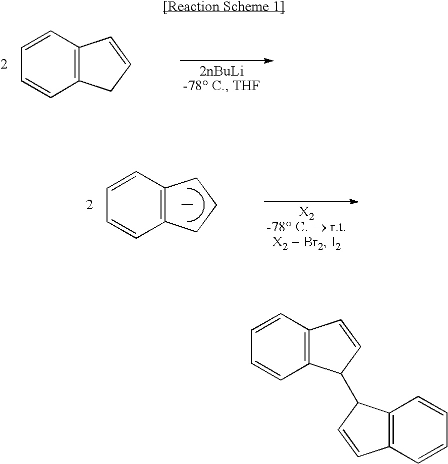

Referring to Reaction Scheme 1, indene is treated with one equivalent of a metal reagent such as nBuLi at a low temperature, for example, less than −30° C., preferably −90° C. to −50° C. In Reaction Scheme 1, the temperature used is −78° C. Then, a half equivalent of a halogenation reagent, such as Br₂, I₂, N-bromosuccinimide, or N-chlorosuccinimide, is added thereto. By this time, in the reaction mixture, about a half of the starting material exists as an indenyl anion, and about the other half exists as 1-X-indene where X is Cl, Br, or I. Then, the reaction temperature is increased to room temperature, thus forming 1,1′-diindenyl.

The metal reagent may be nBuLi as illustrated in Reaction Scheme 1, but the embodiments of the invention are not limited thereto. That is, the metal reagent may be represented by 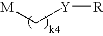
where M is lithium, magnesium chloride, magnesium bromide, copper, silver, sodium, potassium, or mercury; Y is a double bond or a triple bond; R is hydrogen or a C1-C10 alkyl group; and k₄ is an integer from 0 to 10.

For example, the metal reagent may be a compound selected from alkyl lithium reagent, such as n-buthyl lithium, t-butyl lithium, and methyl lithium; aryl lithium such as phenyl lithium; lithium acetylide ethylene diamine complex; lithium amide such as lithium diisopropylamide; lithium aluminum hydride; lithium tetrahydroborate; lithium triethylborohydride; lithium hydride; sodium amide; sodium aluminum hydride; sodium tetrahydroborate; sodium hydride; potassium hydride; potassium tetrahydroborate; alkyl magnesium bromide, such as methyl magnesium bromide, and ethyl magnesium bromide; alkenyl magnesium bromide such as vinyl magnesium bromide; ethynyl magnesium bromide; allyl magnesium bromide; aryl magnesium bromide such as phenyl magnesium bromide; alkyl magnesium chloride, such as methyl magnesium chloride, and ethyl magnesium chloride; alkenyl magnesium chloride, such as vinyl magnesium chloride, and 2-butenyl magnesium chloride; ethynyl magnesium chloride; allyl magnesium chloride; aryl magnesium chloride such as phenyl magnesium chloride; benzyl magnesium chloride; magnesium hydride; and calcium hydride.

Reaction Scheme 2 is a second reaction used to form a diindenyl monomer unit of 3,3′-di(1-X-indenyl).

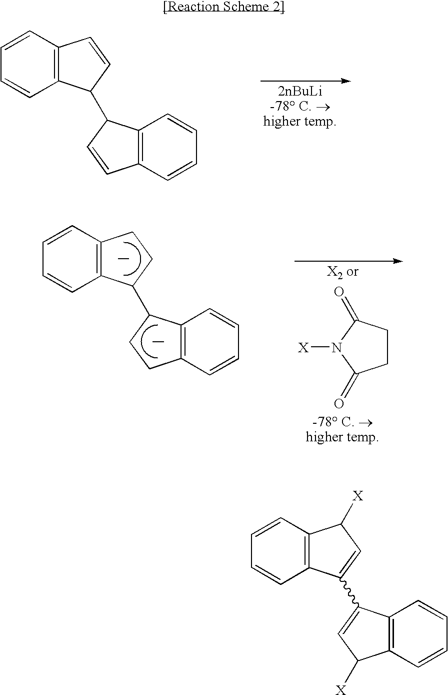

Referring to Reaction Scheme 2,1,1′-diindenyl is treated with two equivalents of a metal reagent at a relatively low temperature, for example, less than −30° C., preferably −90° C. to −50° C. In this reaction, the reaction temperature used is −78° C.

Then, the reaction temperature is increased while ensuring the safety of the reaction, thus forming diindenyl dianion species by double deprotonation. That is, for example, the reaction mixture attained by the addition of two equivalents of a metal reagent at −78° C. is slowly heated until the reaction temperature reaches room temperature, thus producing the diindenyl monomer unit of 3,3′-di(1-X-indenyl) where X is Cl, Br, or I.

In the resulting structure, p-electron conjugation becomes more expanded through two sp² carbon at bridging positions, when compared to its parent 1,1′-diindenyl, since addition reactions of halogen atoms take place so that p-electron conjugation is as wide as possible in the product unless other restrictions such as steric hindrance exist. In this case, 3,3′-di(1-X-indenyl) is mixtures of cis-/trans-isomers along an axis between two indenyl moieties.

Minor products generated in Reaction Scheme 2 may be represented by

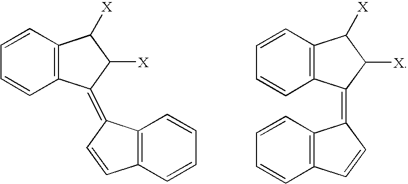

Reaction Scheme 1 and Reaction Scheme 2 may be combined into Reaction Scheme 3 by omitting an isolation of 1,1′-diindenyl.

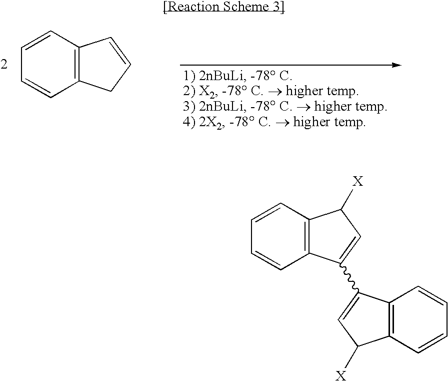

Reaction Scheme 3 can be performed in a single reaction pot, thus increasing product yield and decreasing production costs.

By modifying Reaction Scheme 2, one of the target diindenyl polymers might be directly accessible from 1,1′-diindenyl, which is illustrated in Reaction Scheme 4.

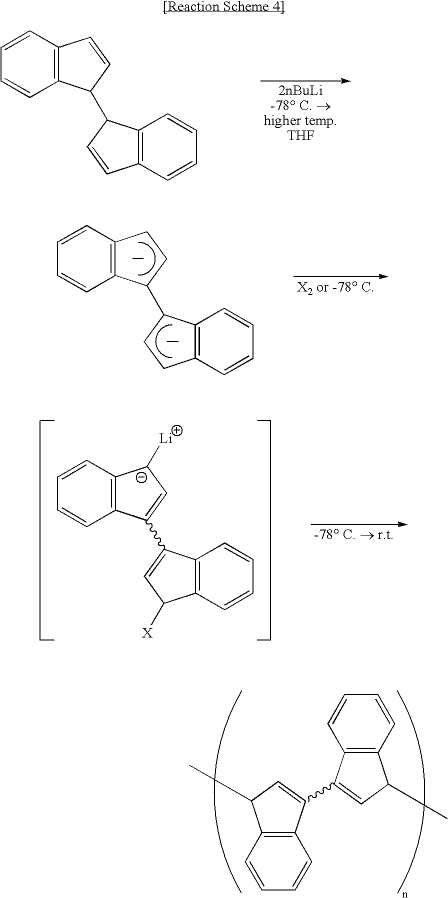

After the generation of diindenyl dianion materials, one equivalent of a halogenation reagent instead of two equivalents in Reaction Scheme 2 is added to the reaction mixture at a relatively low temperature, for example, less than −30° C., preferably −90° C. to −50° C. Then, the reaction temperature is slowly increased to room temperature to give a 3,3′-diindenyl polymer.

These reactions can be combined into one reaction illustrated by Reaction Scheme 5:

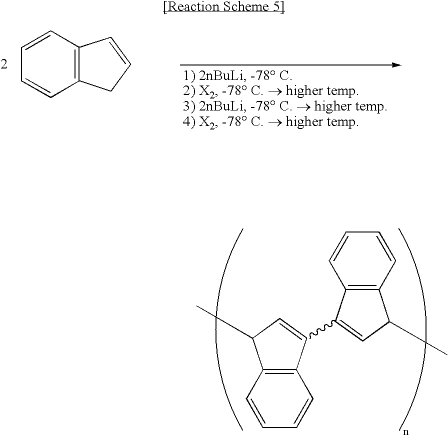

The reaction products obtained from Reaction Schemes 1 to 5 may subjected to a conventional procedure which includes being treated with a sodium thiosulfate aqueous solution, being extracted with organic solvents, and then being dried over drying reagents such as magnesium sulfate or sodium sulfate. Crude products are purified by distillation or column chromatography. In these reactions, ethereal solvents such as tetrahydrofuran, or diethylether may be used. Solvents used must be dried preliminarily over sodium/benzophenone or other appropriate drying reagents. In addition, solvents other than those that have hydroxyl groups, halogen atoms, or other reactive functional groups against metal reagents, such as pentane, hexane, or benzene, may be further used along with the ethereal solvents.

3,3′-di(1-X-indenyl) may be useful as a bottom layer resist starting material for various polymerization reactions.

For a example, oxidation condensation of 3,3′-di(1-X-indenyl) with various bisphenol derivatives, such as 4,4′-(9-fluorenylidene)dophenol or Bisphenol A, might proceed in the presence of potassium carbonate to give the target polymers, which is illustrated by Reaction Scheme 6:

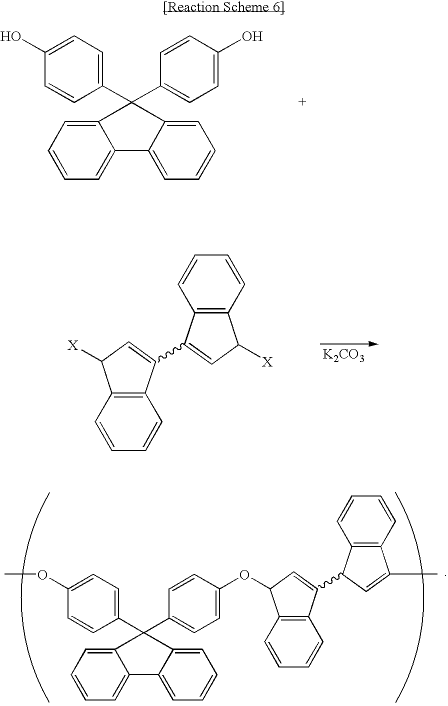

Examples of the bisphenol derivative may include, in addition to bisphenol A, bisphenol AP, bisphenol E, bisphenol F, bisphenol M, bisphenol P, bisphenol Z, and the like. As illustrated in Reaction Scheme 6, a bisphenol derivative monomer unit-containing polymer may be formed from these bisphenol derivatives.

Examples of the bisphenol derivative monomer unit, which composes a bottom layer resist polymer according to an embodiment of the present invention, may be represented by

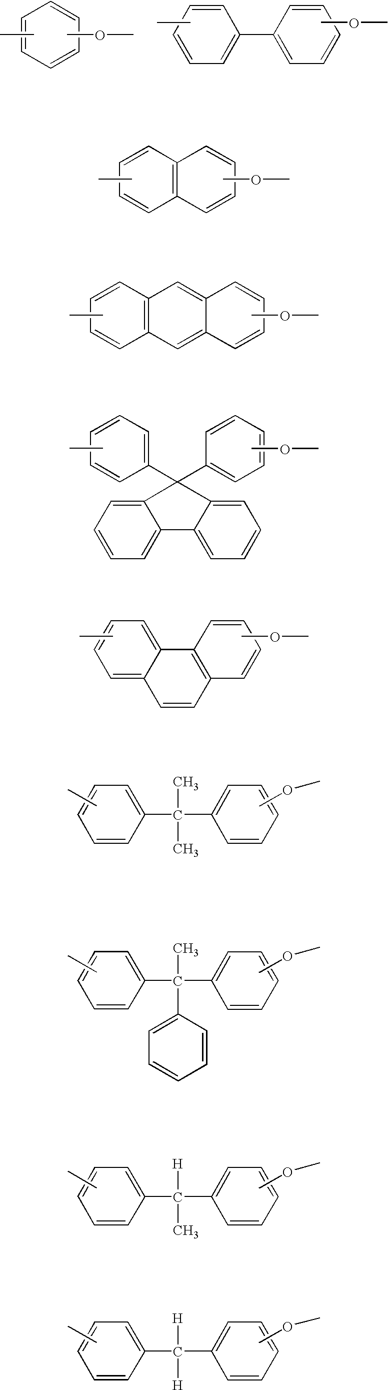

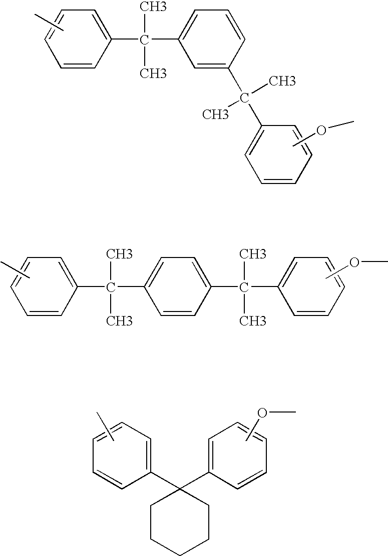

As another example, 3,3′-di(1-X-indenyl) can be converted to 3,3′-di(1-hydroxy-indenyl) in the presence of sodium carbonate, and then oxidation polymerization might proceed in the presence of acid catalyst, which is illustrated by Reaction Scheme 7:

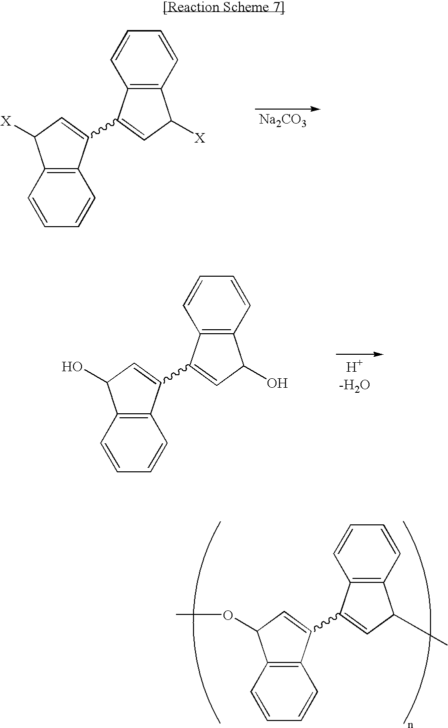

An Ohnishi parameter value calculated for this polymer obtained in this reaction is 1.82. In the case of naphthol resin, for a comparison, the Ohnishi parameter value is 1.89.

Crosslinking groups, such as an unsaturated hydrocarbon halide, can be added to the above polymers. The unsaturated hydrocarbon halide may be represented by 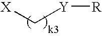
where X is Cl, Br, or I; Y is a double bond or a triple bond; R is hydrogen or a C1 to C10 alkyl group; and k₃ is an integer from 0 to 10.

The polymer obtained in Reaction Scheme 7 is treated with a metal reagent, and then with unsaturated hydrocarbon halide such as propagyl bromide, which is illustrated by Reaction Scheme 8:

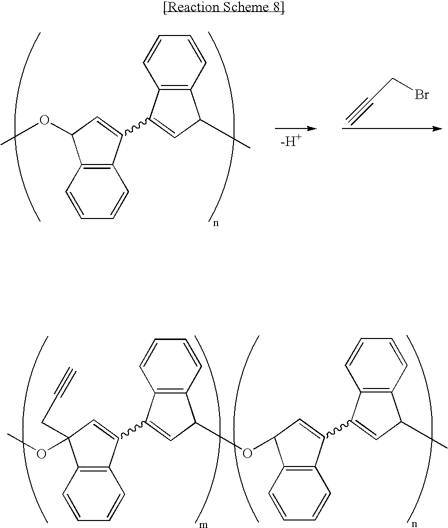

The resulting product obtained in Reaction Scheme 8 is baked, which is illustrated by Reaction Scheme 9:

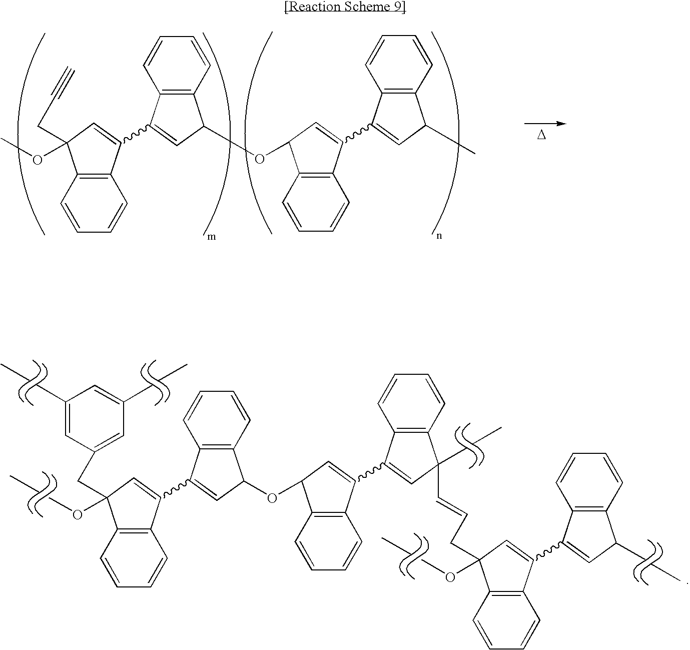

Upon baking, these crosslinking groups might undergo an addition reaction with allyl protons in the 3,3′-diindnyl structure, thus generating a rigid and mechanically strengthened membrane. Therefore, vertical pattern profiles of the membrane are not changed after dry etching using O₂ plasma.

Polymer according to embodiments of the present invention has an expanded p-electron conjugation system based on a monomer unit having a 3,3′-diindenyl structure. Methods according to embodiments of the present invention are characterized by extensive uses of metal reagent for deprotonation and a successive halogenation reaction. In addition, in methods according to embodiments of the present invention, reactions from a starting material to a diindenyl monomer, or from the starting material to a 3,3′-diindenyl polymer, may be performed in a single reaction pot without omitting an isolation of an intermediate product, thus increasing product yield and decreasing manufacturing costs.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A bottom layer resist polymer comprising a repeat unit having a 3,3′-diindenyl structure and represented by the following formula: 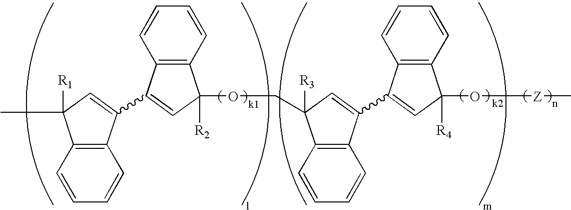
where l, m and n are respective mole fractions of monomer units of the polymer,
where l+m+n=1, where l=0.1 to 0.9, m=0.1 to 0.9, and n=0 to 0.8,
where each of k₁ and k₂ is independently 0 or 1, and each of R₁, R₂, R₃ and R₄ is independently a hydrogen atom or an unsaturated hydrocarbon, and
where Z is a monomer unit comprising a bisphenol derivative.

2. The bottom layer resist polymer of claim 1, wherein n>0, and wherein Z is a monomer unit selected from the group consisting of the following monomer units:

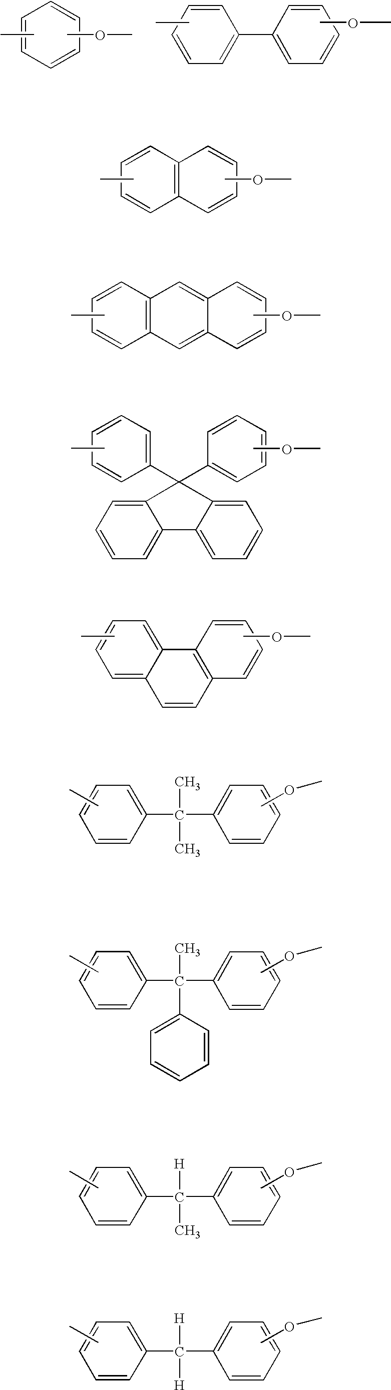

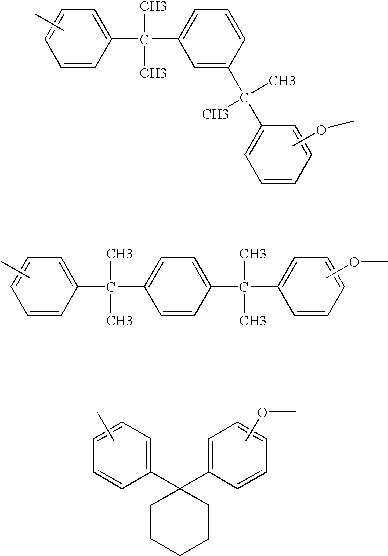

3. A method of manufacturing a bottom layer resist polymer, the method comprising treating a polymer comprising a repeat unit having a 3,3′-diindenyl structure with a metal reagent and an unsaturated hydrocarbon halide, wherein the polymer is represented by the following formula: 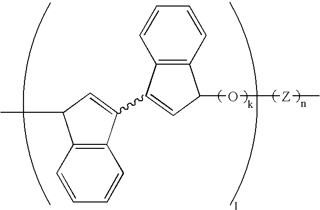
where each of l and n is a mole fraction of respective monomer units,
where l+n=1, l=0.1 to 1.0, n=0 to 0.9, and k is 0 or 1, and
Z is a monomer unit comprising a bisphenol derivative.

4. The method of claim 3, wherein n>0, and wherein Z is a monomer unit selected from the group consisting of the following formulas:

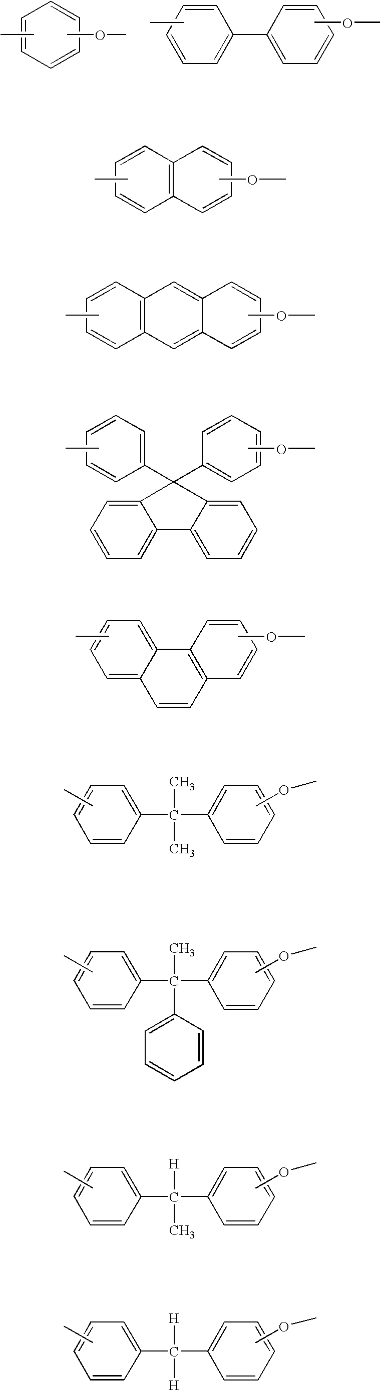

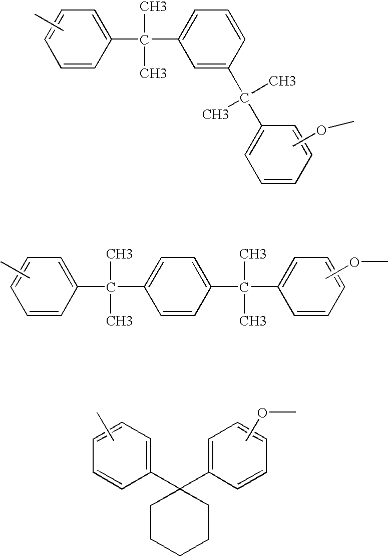

5. The method of claim 3, wherein the metal reagent comprises a compound selected from the group consisting of alkyl lithium, aryl lithium, lithium acetylide ethylene diamine complex, lithium amide, lithium aluminum hydride, lithium tetrahydroborate, lithium triethylborohydride, lithium hydride, sodium amide, sodium aluminum hydride, sodium tetrahydroborate, sodium hydride, potassium hydride, potassium tetrahydroborate, alkyl magnesium bromide, alkenyl magnesium bromide, ethynyl magnesium bromide, allyl magnesium bromide, aryl magnesium bromide, alkyl magnesium chloride, alkenyl magnesium chloride, ethynyl magnesium chloride, allyl magnesium chloride, aryl magnesium chloride, benzyl magnesium chloride, magnesium hydride, and calcium hydride.

6. The method of claim 3, wherein the unsaturated hydrocarbon halide is represented by the following formula: 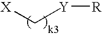
where X is Cl, Br, or I;
where Y is one of a double bond and a triple bond;
where R is one of hydrogen and a C1 to C10 alkyl group; and
where k₃ is an integer from 0 to 10.

7. The method of claim 3, further comprising oxidation polymerization of 3,3′-di(1-hydroxy-indenyl) represented by the following formula in the presence of sulfuric acid:

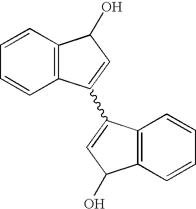

8. The method of claim 7, further comprising forming the 3,3′-di(1-hydroxy-indenyl) by treating 3,3′-di(1-halo-indenyl) represented by the following formula with a sodium carbonate: 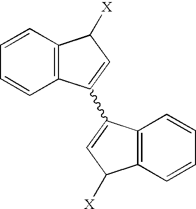
where X is Cl, Br or I.

9. The method of claim 3, further comprising condensation polymerization of 3,3-di(1-halo-indenyl) and the bisphenol derivative in the presence of potassium carbonate.

10. The method of claim 8, wherein 3,3′-di(1-halo-indenyl) is formed by reacting 1,1′-diindenyl with 2 equivalents of the metal reagent to form diindenyl dianion represented by the following formula, and reacting the diindenyl dianion with two equivalents of a halogenation reagent:

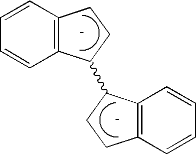

11. The method of claim 10, wherein the metal reagent comprises a compound selected from the group consisting of alkyl lithium, aryl lithium, lithium acetylide ethylene diamine complex, lithium amide, lithium aluminum hydride, lithium tetrahydroborate, lithium triethylborohydride, lithium hydride, sodium amide, sodium aluminum hydride, sodium tetrahydroborate, sodium hydride, potassium hydride, potassium tetrahydroborate, alkyl magnesium bromide, alkenyl magnesium bromide, ethynyl magnesium bromide, allyl magnesium bromide, aryl magnesium bromide, alkyl magnesium chloride, alkenyl magnesium chloride, ethynyl magnesium chloride, allyl magnesium chloride, aryl magnesium chloride, benzyl magnesium chloride, magnesium hydride, and calcium hydride.

12. The method of claim 10, wherein the metal reagent is reacted with 1,1′-diindenyl at a temperature of −90° C. to −30° C. and then the reaction temperature is increased until the diindenyl dianion is formed.

13. The method of claim 10, wherein the halogenation reagent is a compound selected from the group consisting of Br₂, I₂, N-bromosuccinimide, and N-chlorosuccinimide.

14. The method of claim 10, wherein the halogenation reagent is reacted with the diindenyl dianion at a temperature of −90° C. to −30° C. and the reaction temperature is increased until the 3,3′-di(1-halo-indenyl) is formed.

15. The method of claim 10, wherein 1,1′-diindenyl is formed by reacting indene with one equivalent of the metal reagent, and reacting the reaction product with a half equivalent of the halogenation reagent.

16. The method of claim 15, wherein the metal reagent comprises a compound selected from the group consisting of alkyl lithium, aryl lithium, lithium acetylide ethylene diamine complex, lithium amide, lithium aluminum hydride, lithium tetrahydroborate, lithium triethylborohydride, lithium hydride, sodium amide, sodium aluminum hydride, sodium tetrahydroborate, sodium hydride, potassium hydride, potassium tetrahydroborate, alkyl magnesium bromide, alkenyl magnesium bromide, ethynyl magnesium bromide, allyl magnesium bromide, aryl magnesium bromide, alkyl magnesium chloride, alkenyl magnesium chloride, ethynyl magnesium chloride, allyl magnesium chloride, aryl magnesium chloride, benzyl magnesium chloride, magnesium hydride, and calcium hydride.

17. The method of claim 15, wherein the halogenation reagent is a compound selected from the group consisting of Br₂, I₂, N-bromosuccinimide, and N-chlorosuccinimide.

18. The method of claim 15, wherein the metal reagent is reacted with the indene at a temperature of −90° C. to −30° C.

19. The method of claim 15, wherein the halogenation reagent is reacted with the reaction product at a temperature of −90° C. to −30° C. and the reaction temperature is increased until the 1,1′-diindenyl is formed.

20. The method of claim 3, further comprising reacting 1,1′-diindenyl with two equivalents of the metal reagent to form diindenyl dianion represented by the following formula, and reacting the diindenyl dianion with one equivalent of a halogenation reagent:

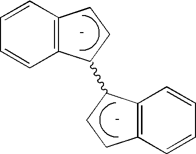

21. The method of claim 20, wherein the metal reagent comprises a compound selected from the group consisting of alkyl lithium, aryl lithium, lithium acetylide ethylene diamine complex, lithium amide, lithium aluminum hydride, lithium tetrahydroborate, lithium triethylborohydride, lithium hydride, sodium amide, sodium aluminum hydride, sodium tetrahydroborate, sodium hydride, potassium hydride, potassium tetrahydroborate, alkyl magnesium bromide, alkenyl magnesium bromide, ethynyl magnesium bromide, allyl magnesium bromide, aryl magnesium bromide, alkyl magnesium chloride, alkenyl magnesium chloride, ethynyl magnesium chloride, allyl magnesium chloride, aryl magnesium chloride, benzyl magnesium chloride, magnesium hydride, and calcium hydride.

22. The method of claim 20, wherein the metal reagent is reacted with 1,1′-diindenyl at a temperature of −90° C. to −30° C., and the reaction temperature is increased until diindenyl dianion is formed.

23. The method of claim 20, wherein the halogenation reagent is a compound selected from the group consisting of Br₂, I₂, N-bromosuccinimide, and N-chlorosuccinimide.

24. The method of claim 20, wherein the halogenation reagent is reacted with the diindenyl dianion at a temperature of −90° C. to −30° C. until a diindenyl dianion intermediate polymer represented by the following formula is formed, and the reaction temperature is increased until a polymer composed of a repeat unit having the 3,3′-diindenyl structure is formed from the diindenyl dianion intermediate polymer:

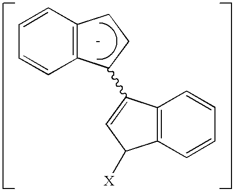

25. A method of forming a bottom layer resist polymer, the method comprising treating a polymer composed of a repeat unit having a 3,3′-diindenyl structure having the following formula with a metal reagent: 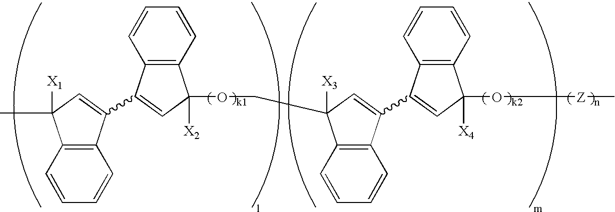
where each of l, m and n is a mole fraction of respective monomer units,
where l+m+n1, l=0.1 to 0.9, m=0.1 to 0.9, n=0 to 0.8, each of k₁ and k₂ is independently 0 or 1, and each of X₁, X₂, X₃ and X₄ is independently a hydrogen atom or a halogen atom, and
where Z is a monomer unit composed of a bisphenol derivative.

26. The method of claim 25, wherein n>0, and wherein Z is a monomer unit selected from the group consisting of the following units:

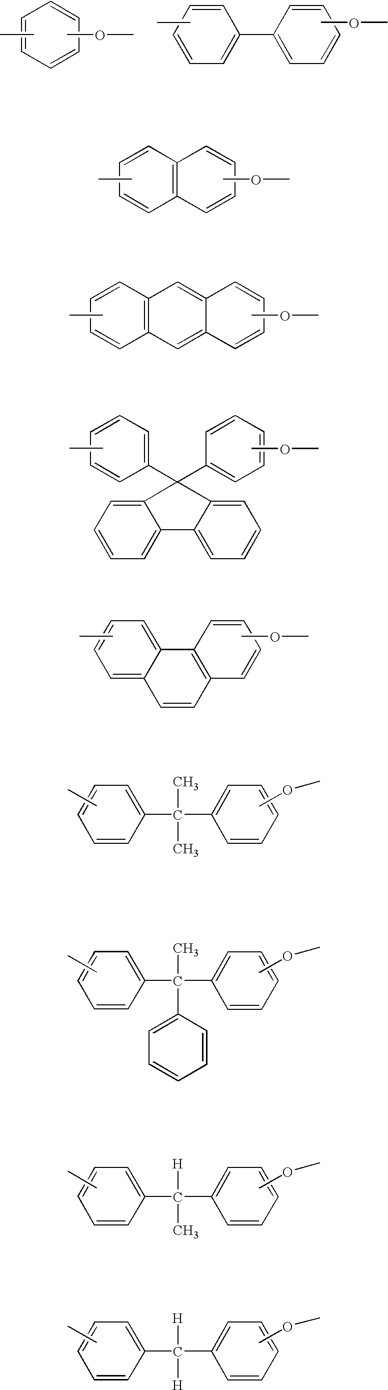

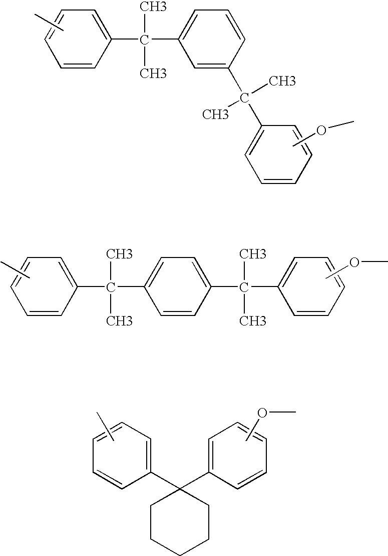

27. The method of claim 25, wherein the metal reagent is represented by 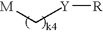
where M is lithium, magnesium chloride, magnesium bromide, copper, silver, sodium, potassium, or mercury,
where Y is one of a double bond and a triple bond,
where R is one of a hydrogen atom or a C1-C10 alkyl group, and
where k₄ is an integer from 0 to 10.

28. A method of forming a bottom layer resist polymer, the method comprising treating a polymer composed of a repeat unit having a 3,3′-diindenyl structure having the following formula with a metal reagent, and then with a halogenation reagent: 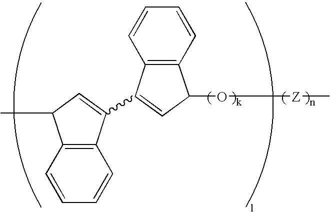
where each of l and n is a mole fraction of respective monomer units,
where l+n=1, l=0.1 to 1.0, n=0 to 0.9, and k is 0 or 1, and
wherein Z is a monomer unit comprising a bisphenol derivative.

29. The method of claim 28, wherein n>0, and wherein Z is a monomer unit selected from the group consisting of the following monomer units:

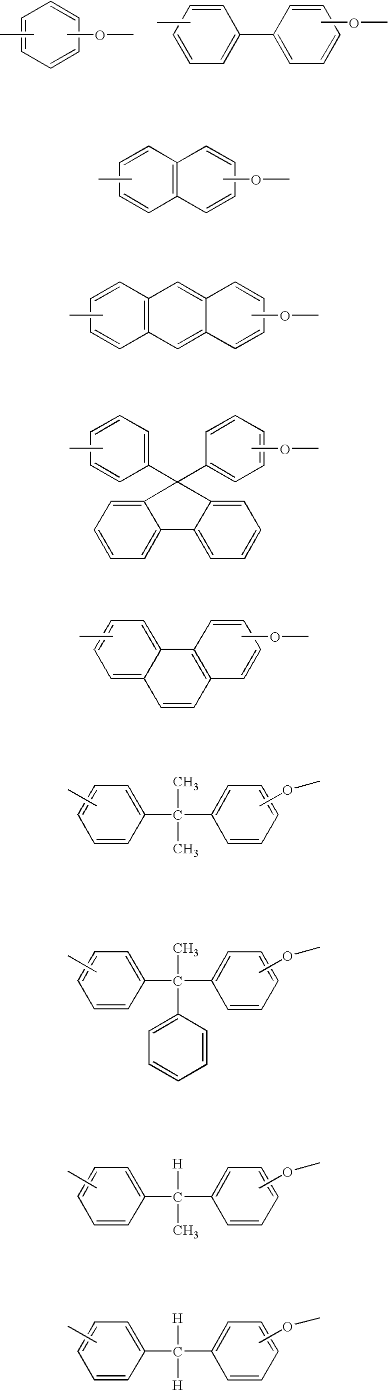

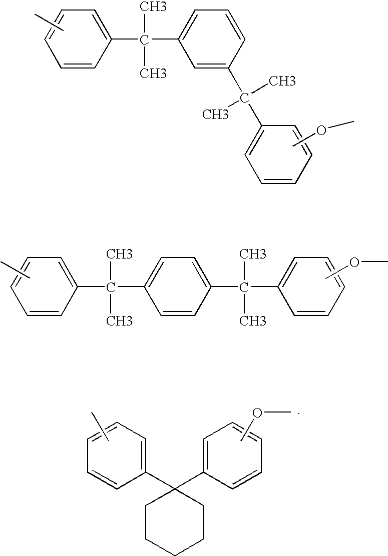

30. The method of claim 28, wherein the metal reagent comprises a compound selected from the group consisting of alkyl lithium, aryl lithium, lithium acetylide ethylene diamine complex, lithium amide, lithium aluminum hydride, lithium tetrahydroborate, lithium triethylborohydride, lithium hydride, sodium amide, sodium aluminum hydride, sodium tetrahydroborate, sodium hydride, potassium hydride, potassium tetrahydroborate, alkyl magnesium bromide, alkenyl magnesium bromide, ethynyl magnesium bromide, allyl magnesium bromide, aryl magnesium bromide, alkyl magnesium chloride, alkenyl magnesium chloride, ethynyl magnesium chloride, allyl magnesium chloride, aryl magnesium chloride, benzyl magnesium chloride, magnesium hydride, and calcium hydride.

31. The method of claim 28, wherein the halogenation reagent is a compound selected from the group consisting of Br₂, I₂, N-bromosuccinimide, and N-chlorosuccinimide.
